(19) United States
(12) Patent Application Publication
(10) Pub. No.: US 2006/0221053 A1
(43) Pub. Date: Oct. 5, 2006

(54) Drum control device for an electronic apparatus

(76) Inventor: Jean-Christophe Villain, Ounans (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/403,097

(22) Filed: Apr. 12, 2006

Related U.S. Application Data
(63) Continuation-in-part of application No. PCT/EP04/52622, filed on Oct. 22, 2004.

(30) Foreign Application Priority Data
Oct. 24, 2003 (FR) FR 0312443

(51) Int. Cl. G09G 5/08

(52) U.S. Cl. 345/157

(57) ABSTRACT

The invention proposes a device (10) of the type comprising a housing (12, 24) in which is arranged a control shaft (22) that is driven by a manual drive drum (66), and that is rotatably connected to at least one member (70) belonging to a generator (22, 70, 16) of control signals or pulses for an electronic apparatus, particularly for the control of the movements of a cursor on a display screen of the apparatus, characterized in that it comprises at least one pair of opposite signal generators (22, 70, 16) whose rotating shafts (22) are parallel and whose two parallel and opposite actuating drums (66) can be accessed simultaneously in the top horizontal face (92) of the housing (24) of the device and can be rotated in only one direction.

### CROSS-REFERENCE

This is a Continuation-In-Part of PCT/EP2004/052622 filed 22 Oct. 2004 which designated the US and which claimed priority from French application 0312443 filed 24 Oct. 2003.

### BACKGROUND OF THE INVENTION

The present invention relates to an electric control device with multiple switching channels.

The invention relates to a control device intended to be fitted to an electronic apparatus that can be carried by a hand of a user such that the latter, by means of a single finger, and for example his thumb, may perform distinct electric switching operations in order for example to control a function of the apparatus following choices made by selecting from a menu or a list of a display screen, for instance of a display screen belonging to this apparatus.

Such a control device may further be fitted to a portable computer or a “mouse” and be actuated by the index finger of the user.

More particularly, the object of the invention is to design a control device used for example in a portable telephone (GSM or UMTS) or an “Electronic notebook” whose screen comprises icons or pictograms arranged in a rectangular matrix, that is to say along horizontal and vertical lines.

It is thus desirable to be able to move rapidly and reliably to reach any one of the icons from any point on the screen, that is to say from another icon.

Then, when the choice has been made (that is to say when an icon has been selected), the requirement is to be able to confirm this choice by means of the same device, that is to say by means of the control device and to do this without having the user to move his finger too far.

U.S. Pat. No. 5,563,361 has already proposed a portable electronic apparatus that is fitted with several control devices, or electric switches, that are arranged on the lateral periphery of the parallelepipedic rectangle housing of the electronic control apparatus along several lateral faces with a supplementary central selection device,

These distinct control devices consist for example of rollers or drums arranged along orthogonal axes.

This solution is not satisfactory to the extent that, on the one hand, it multiplies the number of devices or components that the electronic apparatus must comprise and to the extent that, on the other hand, it requires the use of several fingers of the user and culminates in an assembly whose user-friendliness is unacceptable.

Also known are integrated control devices of the ball type, also called “trackballs”, which are used to act by means of a single control device comprising a single actuation member in the form of a ball or rollerball.

However, this type of device is more confined to apparatus known as “top of the range”, particularly due to their cost, and it is difficult to integrate into many items of electronic apparatus due to their too great height or thickness.

It has also been proposed in U.S. Pat. No. 6,633,277, a device comprising an arrangement of two pair of rollers having a parallel axis of rotation which can be actuated simultaneously in the upper horizontal face of the housing.

The object of the invention is to propose a control device of simple design, low cost and very good reliability with an improved ergonomic when compared with the prior art.

### SUMMARY OF THE INVENTION

The invention proposes a control device of the type comprising a housing in which is arranged a rotating horizontal control shaft that is able to be rotated by a manual drive drum supported by the shaft to which it is rotatably connected, and of the type in which the shaft is rotatably connected to at least one rotary member belonging to a generator of control signals or pulses for an electronic apparatus, particularly for the control of the movements of a cursor on a display screen of the apparatus, characterized in that it comprises at least one first pair of opposite signal generators whose rotating shafts are parallel and whose two parallel and opposite actuating drums can be accessed simultaneously in the top horizontal face of the housing, in that each control shaft is active for generating signals or pulses only when it is rotated in one single direction, and in that the said single directions of rotation of the two opposite control shafts of said at least first pair of opposite signal generators are opposite directions.

The design according to the invention can thus be used to place a control device having the form of a discrete, compact component and of very small dimensions used for example for moving a cursor, or equivalent, on a screen and/or for scrolling down menus on apparatus of the “mobile telephone” or “personal digital assistant” (PDA) type offering increasing numbers of functions and services using in particular options proposed on one or more screens in a similar manner to the use of a portable computer.

Thanks to the design according to the invention, the various operations of the control device by means of the bottom face of the thumb of the hand that is holding the apparatus are easy and can be performed ergonomically in all directions with great user-friendliness and low actuating effort.

According to other characteristics of the invention:
the axes of rotation of the two control shafts of the said first pair are arranged in a horizontal plane;
the said two opposite drums are spaced transversely one from the other and, between them, the said two opposite drums transversely delimit a central recess in which a button is arranged for the vertical actuation of a central activation member belonging to a supplementary electric switching channel of the control device to generate selection signals, or pulses;
the selection activation member is a central member of conductive material and of generally. bulbous form which is elastically deformable from a stable, high rest position to a low selection position in order to establish an electric link between two fixed contacts of the housing;
in the high rest position of the activation member, the highest point of the top free actuation face of .the selection button is offset vertically below the plane of the horizontal top face of the housing;
the control device ‘comprises a first pair and a second pair of opposite signal generators whose rotating shafts are parallel and whose two parallel and opposite actuating drums can be accessed simultaneously in the top horizontal face of the housing and the axes of rotation of the four control shafts are arranged in such a way as to form a quadrilateral rectangle, and in particular a square;
the axes of rotation of the four control shafts of the said two pairs are arranged in a horizontal plane;
the four actuating drums are arranged in a square, and the axial ends of two consecutive drums are adjacent to allow the simultaneous actuation of these two drums by one finger of the user;
each control shaft of said second pair is active for generating signals or pulses only when it is rotated in one single direction, and the said single directions of rotation of the two opposite control shafts of said second pair of opposite signal generators are opposite directions.
the outer peripheral surface of each actuating drum comprises surface state characteristics facilitating its actuation by a finger of a user in the said single direction of rotation;
the control device has a general symmetry of design about a central vertical axis of symmetry.

The novel features of the invention are set forth with particularity in the appended claims. The invention will be best understood from the following description when read in conjunction with the accompanying drawings.

### BRIEF DESCRIPTION OF THE DRAWINGS

Other features and advantages of the invention will appear on reading the following detailed description. To understand the latter, refer to the appended drawings in which:

FIG. 1 is an exploded view in perspective of the main components of a first embodiment of a control device according to the teachings of the invention;

FIG. 2 is a view in perspective that illustrates, in assembled position, all the components of the control device according to FIG. 1, without its top body or cover;

FIG. 3 is a top view in perspective of the bottom body only;

FIG. 4 is a top view on a larger scale of the bottom body shown in FIG. 3;

FIG. 5 is an exploded view in perspective of the four control shafts and four sets of associated contact elements (fixed and mobile);

FIG. 6 is a view similar to that of FIG. 5 which illustrates, on a larger scale, the control shafts and the sets of contact elements in their relative positions that they occupy in the bottom body, in mounted position;

FIG. 7 is a view in perspective on a larger scale of one control shaft;

FIG. 8 is a top view in perspective on a larger scale of the central selection control button;

FIG. 9 is a bottom view in perspective of the button in FIG. 8;

FIG. 10 is a bottom view in perspective and on a larger scale of the top body or cover;

FIG. 11 is a side view of the control device;

FIG. 12 is a detail view on a large scale and in section through a vertical and transverse mid-plane of the control device;

FIG. 13 is a top view on a large scale of the control device according to the first embodiment;

FIG. 14 is a top perspective view on a large scale of a second and preferred embodiment of a control device according to the invention;

FIG. 15 is an exploded view in perspective of the main components of the control device of FIG. 14;

FIG. 16 is a perspective view that illustrates, in the assembled position, mainly all the components of the control device according to FIG. 15, without its top cover;

FIG. 17 is a top plan view on a larger scale of the four control shafts and four associated mobile contact elements;

FIG. 18 is a view similar to that of FIG. 15 which illustrates, on a larger scale, the top cover and one control shaft with its associated actuating drum, together with the associated mobile contact element;

FIG. 19 is a view similar to FIG. 18 under another perspective angle;

FIG. 20 is a perspective view of a variant of a control shaft including overrun clutching means;

FIG. 21 is a view similar to FIG. 20 under another perspective angle;

FIGS. 22 and 23 are two top views illustrating the functioning of the overrun clutching means in association with the mobile and fixed contact elements of the first embodiment.

### DESCRIPTION OF THE INVENTION

In the following description, identical, similar or analogous components will be designated by the same reference numbers.

In a non-limiting manner, to facilitate the comprehension of the description and of the claims, the vertical, horizontal, top, bottom etc. terms will be adopted with reference to the figures and on the trihedron L, V, T illustrated in the figures, the longitudinal directions L and the transverse directions T defining the horizontal plane.

The embodiments of the control device according to the invention illustrated in the figures have a general symmetry of design about a central vertical axis A.

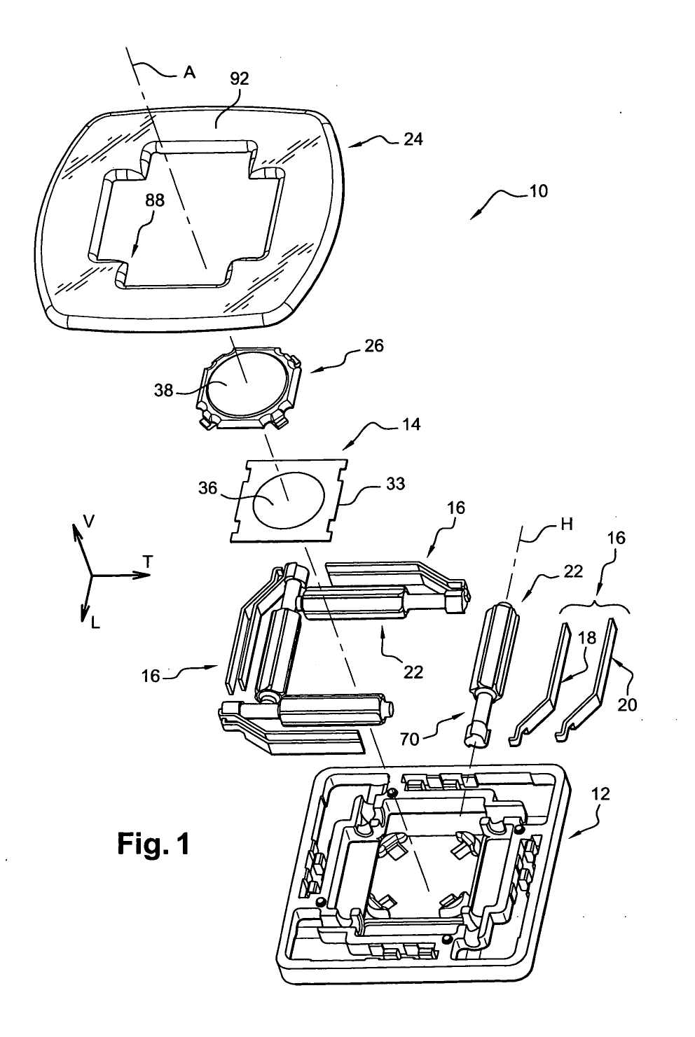

The control device 10, as it can be seen in FIG. 1, consists mainly in an axial stacking on the general axis A of five components or groups of main components comprising a bottom body 12, a central selection activation member 14, a series of four sets 16 of pairs of elements of fixed contacts 18 and mobile contacts 20 belonging to as many (four) control signal generators, four rotating control, or coding, shafts, 22 each of which is associated with a set of contact elements 16 and is capable of being rotated, in a single direction, about its horizontal axis “H” and further a top body or cover 24 in general plate form which, with the bottom body 12, constitutes the housing of the control device 10.

The axes of rotation “H” of the four control shafts 22 are coplanar and are situated in a horizontal plane.

As can be seen in FIG. 1, the device 10 also comprises a central control button 26 for acting on the central activation member 14 of the selection switching channel.

The bottom body 12 essentially consists of a piece made of insulating moulded plastic whose top face 28 is open to give access to various internal seats or cavities and which is delimited by a bottom 30.

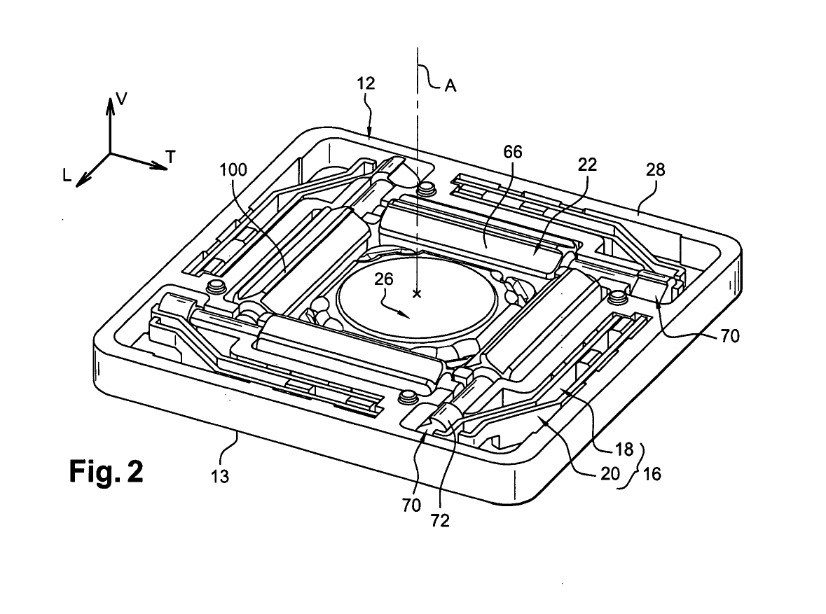

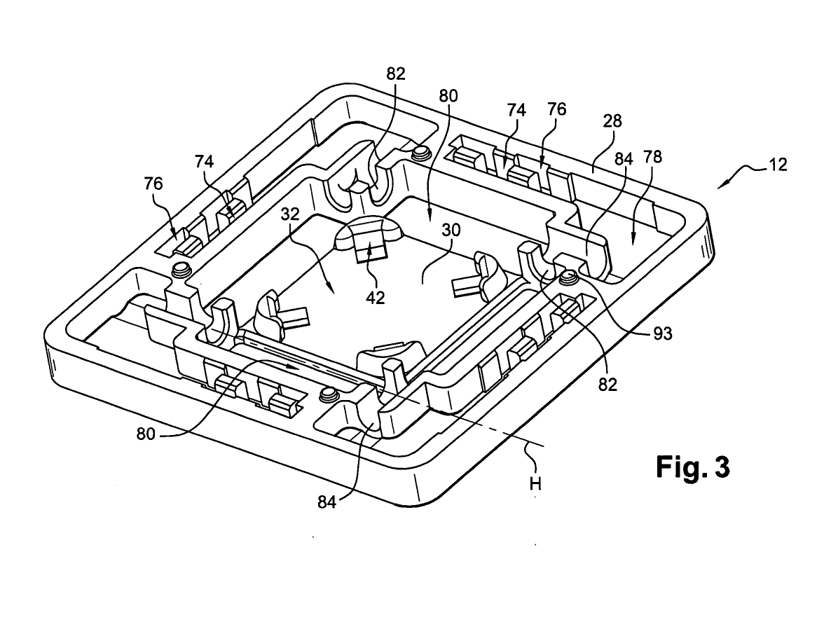

As it can be seen in greater detail in FIGS. 2 and 3, the bottom body 12 delimits a central cavity 32 intended to receive the central activation member 14 which, according to a general design known in the field, is a generally dome-shaped member which rests by its bottom, square-shaped peripheral edge 33 in the bottom 30 of the cavity 32 and whose top, actually dome-shaped, central portion 36 extends, in the stable rest state of the member 14, vertically above and at a distance from the bottom 30.

Accordingly to a known arrangement not shown in detail in the figures, the bottom 30 of the cavity comprises peripheral conducting pads linked electrically to the edge 33 of the member 14 and a central conducting pad facing the central portion of the dome 36 such that any downward vertical action on the latter establishes an electrical link between the central and peripheral pads to establish, that is to say close, the selection switching channel.

Specifically, the activation member 14 is made of conductive material which, by the action of a downward pressure applied to it via the button 26, deforms and then collapses suddenly to establish the selection switching channel.

When the pressure applied to the top face 38 of the button 26 is released, the member 14 returns of its own accord to its normal rest state thereby reopening the selection switching channel.

Due to its own elasticity, the member 14 also constitutes, in the embodiment shown, the elastic member for returning the button 26 to the up position.

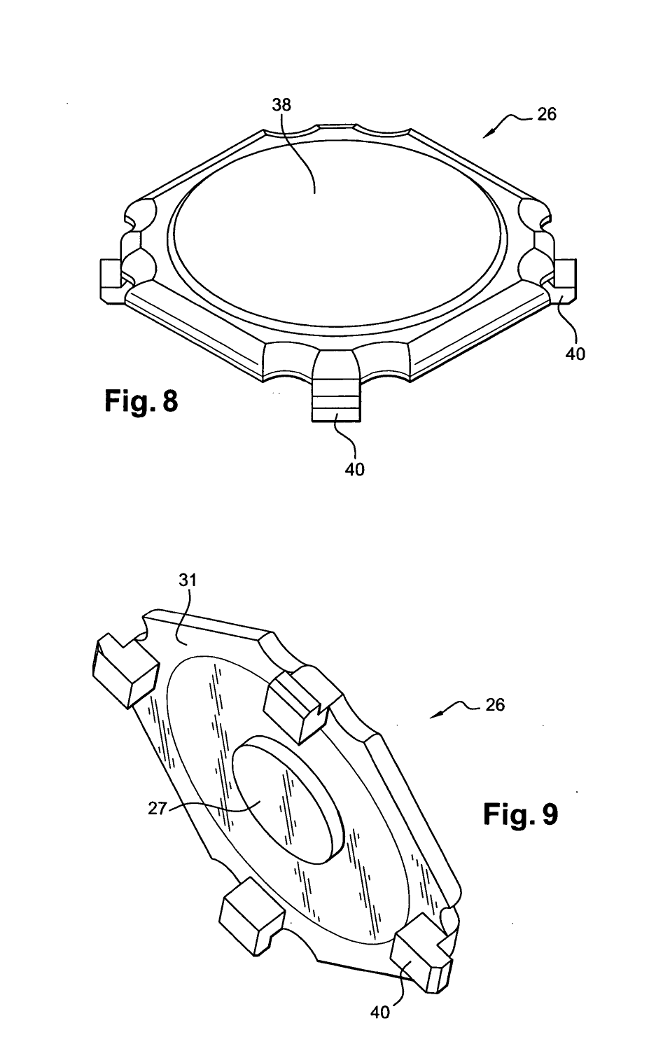

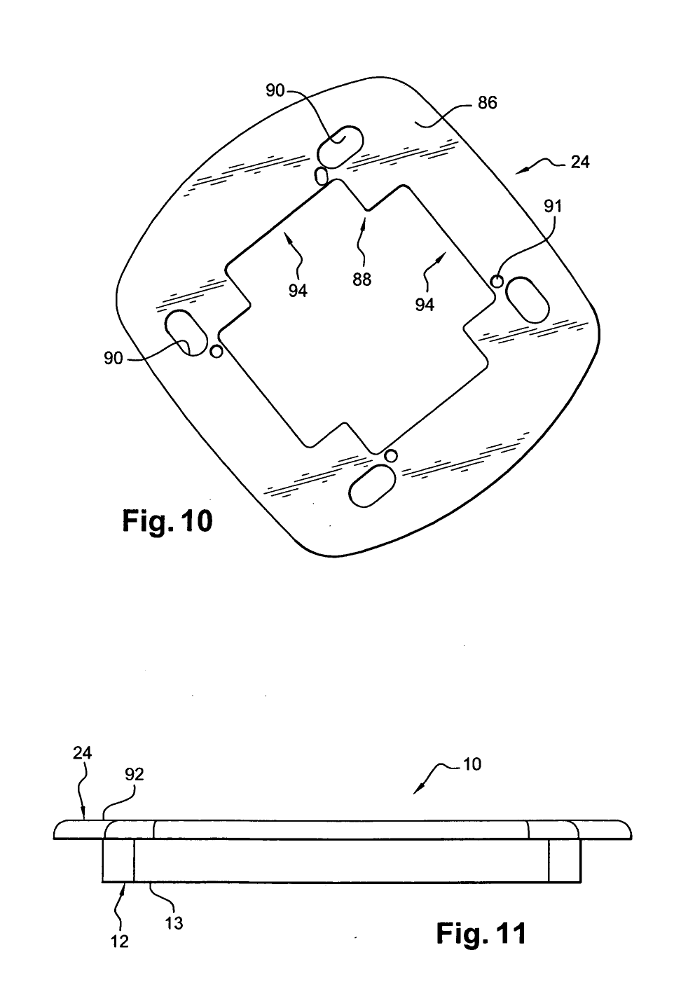

The button 26 is, as can be seen in particular in FIGS. 8 and 9, a piece made of insulating moulded plastic generally square in shape which comprises, at each of its corners or elbows a foot or leg 40 for guidance and positioning which extends vertically downwards and which is received in a matching seat 42 shaped for this purpose in a corresponding elbow of the central cavity 32.

Furthermore, the conformation of the feet 40 and of the seats 42 ensures the angular positioning without play in the horizontal plane L, T of the button 26 and of the activation member 14.

Each leg 40 also presses upwards against an opposite portion of the bottom face 86 of the cover to define the top rest position of the button 24.

To reduce the number of different components, the mobile contact 18 and fixed contact 20 are preferably of identical design.

Each contact 18, 20 is made in the shape of a strip of conductive material cut out and bent and each of them comprises an installation and fixing rear section 50, 52, an intermediate section 54, 56 that forms an elbow relative to the rear rectilinear section 50, 52 and a front end section 58, 60 which is a rectilinear section, parallel to the rear section 50, 52, which terminates in a free front end foot 62, 64 which extends in a vertical plane and which is orthogonal to the general vertical plane of the rear installation sections 50 and 52.

The front end section 58 of the mobile contact 18 forms the control section of the mobile contact 18 with which the associated control shaft 22 interacts in order to elastically deform the intermediate section 54 so that the outer lateral face 59 of the front end section 58 comes into contact with the vertical free end face of the foot 64 of the fixed contact 20.

The elasticity that the section 56 of the fixed contact 20 also has allows, when the section 58, 59 comes into contact on the foot 64, the foot 64 also to deform elastically slightly outwards thus making it possible to provide a contact pressure without a “crushing” phenomenon and also procuring a self-cleaning effect by relative movement of the two metal elements in contact.

As can be seen in FIG. 7, the control shaft 22 comprises a rear body or drum 66 controlling its rotation about the axis “H” and is extended axially by an intermediate section 68 which terminates in a cam 70 for controlling the movements of the mobile contact 18.

Accordingly, the cam 70 comprises, in the example illustrated, three protruding lobes or bosses 72 which project radially outwards and which, depending on the relative angular position of the drum 66 (and therefore of the cam 70) relative to the associated control section 58 of the signal generator 16-22, is capable of acting on the inner lateral face 57 of the control section 58 to provoke the formation of a control signal, that is to say to establish a switching, channel between the contacts 18 and 20.

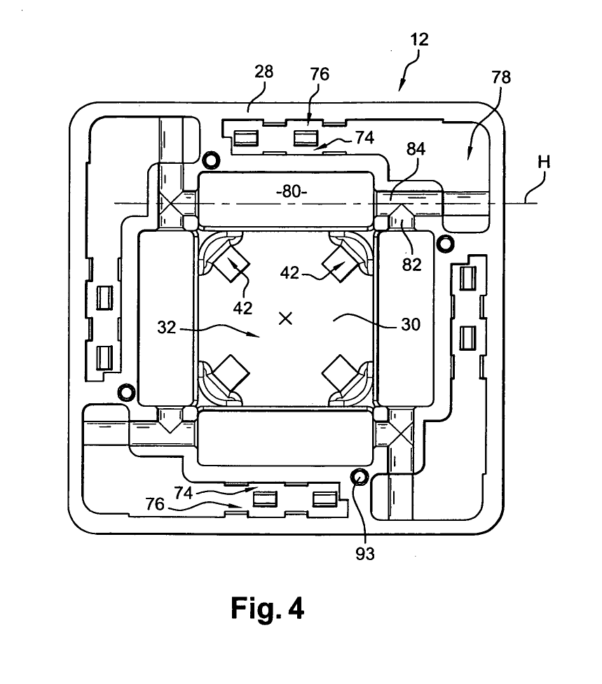

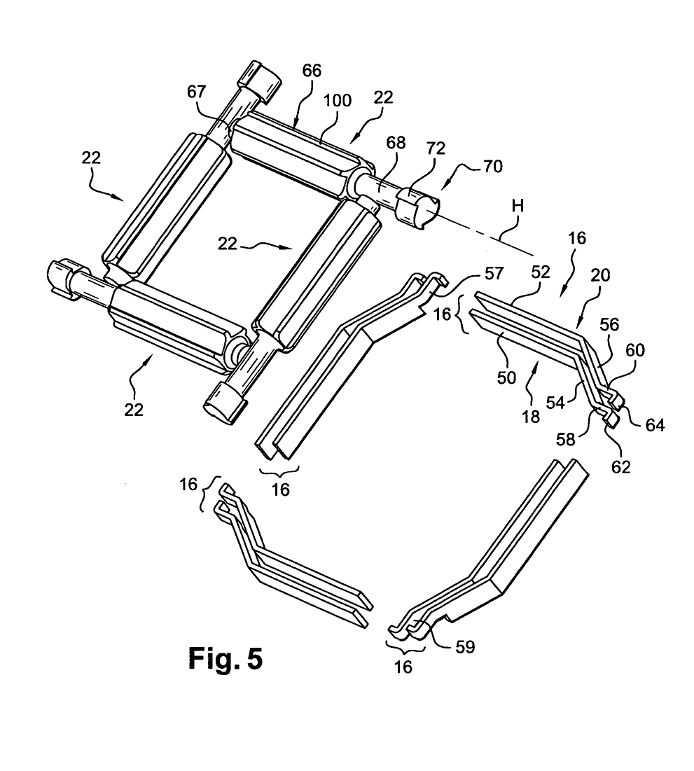

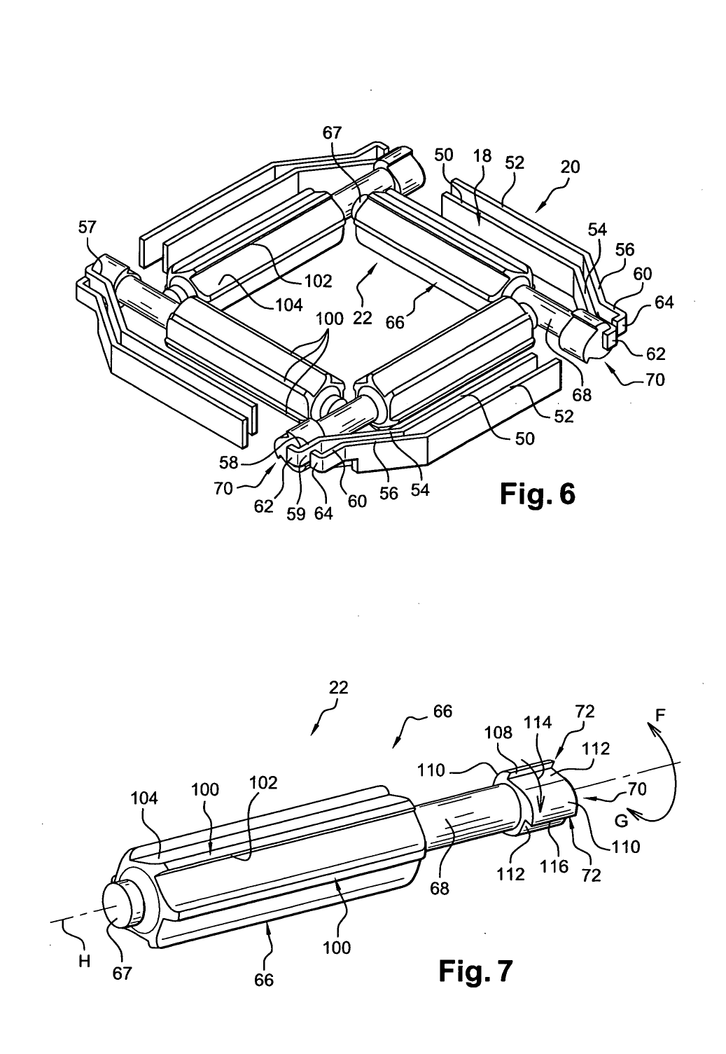

As can be seen in FIGS. 3 and 4, the bottom housing 12 comprises cavities or slots 74, 76 each of which receives the rear section 50, 52 of the mobile contact 18 and of the fixed contact 20 respectively.

The positioning and locking provided by the slots 74 and 76 are such that the functional ends 58 and 64 are received, in the vicinity of an elbow of the bottom body 12, in a cavity 78.

According to a design not shown, the bottom body 12 comprises conducting pads to which the rear sections 50 and 52 of the fixed contacts 20 and mobile contacts 18 are connected. The bottom body naturally also comprises output or connection terminals or pins, not shown and connected to the various conducting pads previously mentioned, which allow the device to be connected for example to the conducting tracks of a printed circuit board of an electronic apparatus fitted with the device 10.

The bottom body 12 further comprises, for each control shaft 22, a cavity 80 in which the body 66 of the actuating drum is rotatably received.

The guidance in rotation of the shaft is provided by two semi-cylindrical rear seats 82 and front seats 84 which respectively receive a rear end cylindrical section 67 and the intermediate section 68 of the corresponding shaft 22.

In the closed position of the housing, that is to say when the top body 64 is in mounted position and assembled onto the top face 28 of the bottom body 12, the sections 67 and 68 are trapped in the seats 82 and 84.

The top body or cover 24 is of general square shape matching that of the bottom body 12 and it is delimited by a bottom flat face 86 which presses against the top face 28 of the bottom body 12.

The seats 82 and 84 also provide the axial positioning, along the axis “H”, of each control member 22 so that the control cam 70 is in functional position facing the control section 57, 58 of the mobile contact 18.

In addition to its central cut-out 88, the top body or cover 24 comprises, in its bottom face, four recesses or cavities 90 each of which rotatably receives the top section of the cam 70, and this it does in order to limit the total overall height of the control device 10 which corresponds to the dimension between the bottom horizontal face 13 of the bottom body 12 and the highest point of the top face 92 of the cover 24.

The bottom face 86 further comprises four blind holes 91 each of which receives a corresponding lug for positioning and fixing the bottom body 12.

The central cut-out 88 of the cover 24 provides access, on the one hand, to each control drum 66 and, on the other hand, to the central button 26.

Accordingly, the central cut-out 88 is of general square shape and it comprises four recesses 94 of general rectangular shape such that the corresponding drum 66 is rotatably received therein.

Each cut-out or cavity 94 is of elongated form like the drum 66, with its length along the axis “H” which is substantially equal to 8 mm.

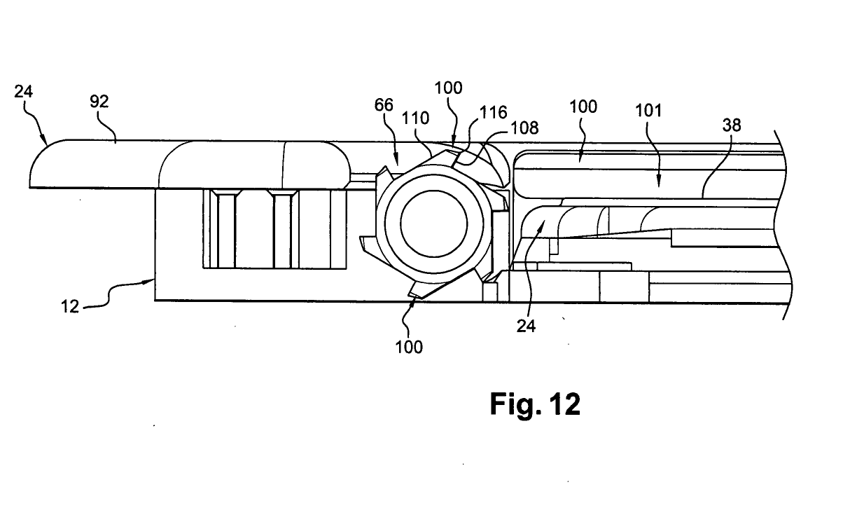

As can be seen in FIG. 12, the dimensions of the cover 24 may be greater than those of the bottom body 12.

Specifically, in addition to its function as top body or cover of the housing of the control device 10, the piece 24 is also a piece of trim and style whose shapes and dimensions may vary depending on the client, that is to say depending on the electronic apparatus that will be fitted with the device 10.

Thus, in mass production, all the components are identical except for the top which is the last component put in place and which is customized according to the client.

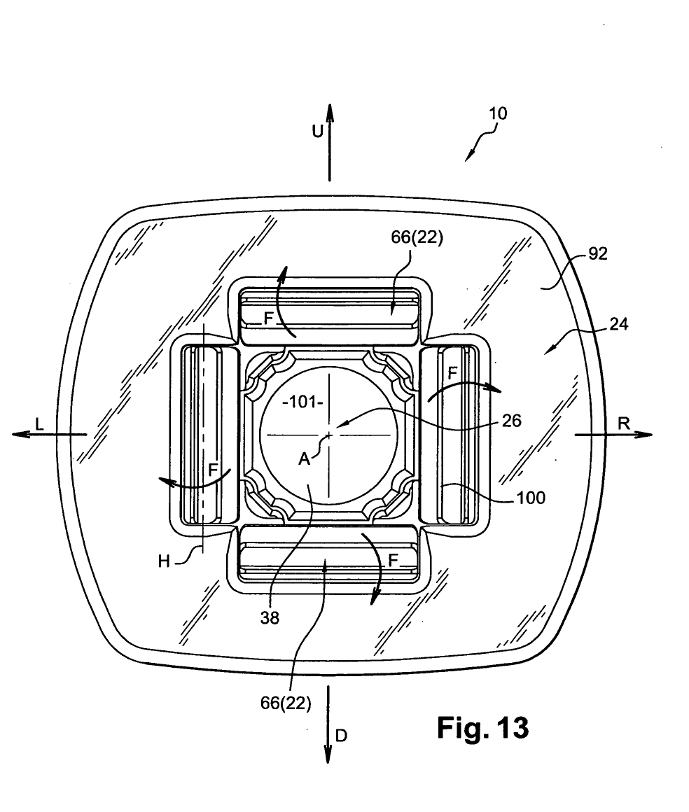

As can be seen in the too view of FIG. 13, the conformation and the dimension of the central button 26 are such that it is adjusted, with slight play, between the four control drums 66.

Thus, the control device 10 offers its user a central selection button 26 and four peripheral control drums 66, the reduced dimensions of the whole of the component comprising the device 10 being such that the user can act with the aid of his thumb on the button 26 and on one or more of the drums 66 without having to move his thumb far from a central position in which he can simultaneously access the button 26 and one or more of the control drums 66.

The distance separating the axes of rotation “H” of two parallel and opposite drums is substantially equal to 8 mm.

The outer peripheral surface of each drum 66 comprises a series of protruding elements 100 each of which is here an axial rib which extends the whole length of the drum 66.

In section through a transverse plane perpendicular to the axis “H” (see FIGS. 7 and 12), the inverted V profile of each axial rib 100 is inclined relative to a substantially median radial plane such as, for a finger of the user, to provide the sensation of a “notch” when the latter moves his thumb transversely relative to the axis “H” in one direction and he comes into contact with a first “concave” lateral face 102 whereas, on the contrary, he feels an inverse “sliding” sensation when his thumb comes into contact with the other “convex” lateral face 104 of the rib 100.

The direction of inclination of each rib 100 corresponds, as can be seen in particular in FIG. 7, to the direction of inclination of the profile of each lobe 72 of the cam 70.

Each lobe 72 has here a dissymmetrical profile relative to a radial plane passing through the axis “H”.

Each active portion or lobe 72 thus has one flat axial lateral face 108 and one opposite convex lateral face of rounded profile 110.

When a drum 66 rotates about its axis “H” in the direction of the arrow F indicated in FIG. 7, the control section 57, 58 first extends facing a flat facet 112 of connection between the lateral face 108 of one lobe 72 and the lateral face 110 of the . immediately consecutive lobe 72.

When the foot 62 Is opposite 112, there is no deformation of the mobile contact and the switching channel for selection or scanning is open.

Then the control section 57, 58 which follows the path indicated by the arrow 114 in FIG. 7, interacts progressively with the convex lateral face 110 whose radius is increasing, which causes a displacement of the control section 57, 58 until it establishes the contact of the outer lateral face 59 with the foot 64 to establish the corresponding switching channel.

When the control section 57, 58 passes the axial edge 116 corresponding to the intersection of the two lateral faces 110 and 108 of a lobe, due to its own elasticity, it suddenly “drops” opposite the next facet 112 while reopening the selection switching channel (“Scanning”).

Due to the dissymmetrical conformation of the lobes 72 of the control cam 70, the latter prevents the drum 66 from rotating in the other direction or sense of rotation, that is to say in the direction of the arrow G (opposed to the arrow F).

Specifically, in this case the control section 57, 58 butts up against the lateral face 108 which it cannot get past.

As can be seen in FIG. 9, the bottom face 31 of the button comprises a central finger 27 vertically protruding downwards for the actuation of, the central dome 36 of the activation member 14.

As can be seen in the sectional view of FIG. 12 in the mounted and assembled position of the various components, the top face 92 of the cover 24 is a horizontal face.

Relative to the plane of this face 92, the radially outermost edges 116 of the drums 66 are situated very slightly below, that is to say substantially flush with the plane of the upper face 92.

However, the highest point of the top face 38 of the button is situated vertically lower, clearly sunken relative to the plane of the face 92.

Thus, between the four peripheral drums 66, there is a central recess 101 delimited vertically below the button 26 which naturally receives the bottom face (not shown) of the thumb of the user.

This vertical difference thus makes it possible to offer, for each drum 66, a large lateral “leading”, convex portion (oriented towards the center of the device 10) of the drum for the thumb of the user when the latter moves it in the direction of the drum from the button.

The ribs 100, with their concave inclined faces, allow an easy rotation in a single direction and at the same time allow an axial sliding of the thumb along each drum 66.

In addition, the positioning in a square with very small dimensions of the four drums 66 allows the simultaneous actuation of two adjacent drums such as to allow for example the control of a diagonal cursor movement.

With reference to the top view illustrated in FIG. 13, it can be seen that the four control drums or rollers 66 each, by their rotation in a single direction, make it possible to produce signals on a switching channel which is associated for example with the control of the movements of a cursor on a screen of an electronic apparatus (not shown).

The four control shafts, and therefore the four control drums 66 are arranged in functional pairs of opposite signal generators such that the two shafts 22 of one pair can be used to produce signals on opposite switching channels corresponding for example to the control of the movements of a cursor on a screen on one and the same straight line, but in opposite directions.

Thus, considering the orientation of FIG. 13, the top roller 66, which constitutes a first pair with the bottom roller, makes it possible by its rotation indicated by the arrow “U” to control “Up” cursor movements whereas the parallel roller 66, below and opposite, is used to control “Down” movements when it is rotated in the direction of the arrow “D”.

Likewise, the left roller 66, which forms a second pair with the right roller, can be used to control the cursor movements to the left, when it is rotated in the direction indicated by the arrow “L”, whereas the right parallel and opposite roller 66 can be used to control movement to the right when it is rotated in the direction of the arrow “R”.

The four rollers are arranged in a square around the central selection button or pad 26.

The conformation with the ribs 100 of each roller 66 and the choice of the materials of which they are made also allows the finger of the user (his thumb) to slide axially along each roller without causing any corresponding rotation of the roller in question.

Thus, for example, the conformation of the left roller 66 allows the finger of the user to slide axially along the latter in the directions indicated by the arrows “U” and “T” without causing the roller to rotate in the direction of the arrow “L”.

When the user attempts to act on a roller to rotate it in an “unauthorized” direction, for example when he attempts to rotate the right roller in the direction opposite to the arrow “R”, on the one hand his finger slides globally on the peripheral surface due to the inclination of the ribs 100 and, on the other hand, he encounters a mechanical resistance which is because a lobe 72 of the cam 70 is butting up against the control section 57, 58 of the mobile contact strip 18.

Thus, according to the invention, each control shaft (22) is active for generating signals or pulses only when it is rotated in one single direction or sense of rotation, and the single directions of rotation of the two opposite control shafts of a pair of opposite signal generators are opposite directions.

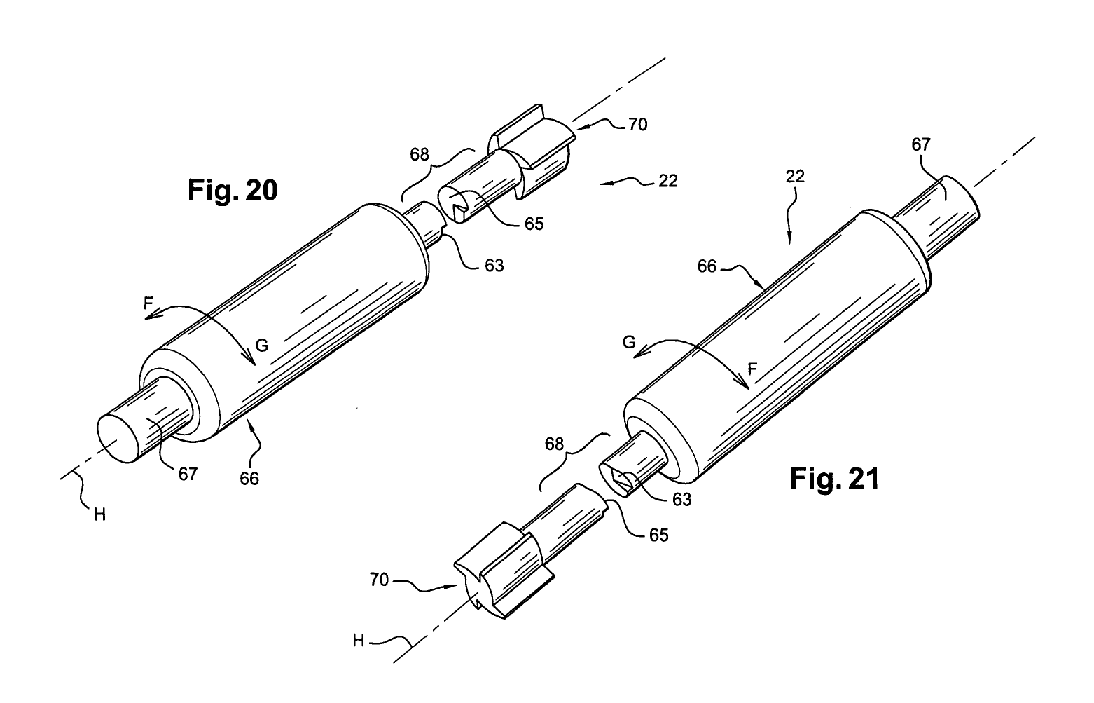

In order to avoid that a user would destroy a pulse generator by exerting an excessive effort for driving a drum in its non authorized direction or sense of rotation G, it is possible to provide each shaft with overrun clutching means such as those illustrated in FIGS. 20 to 23.

To this end, the intermediate section 68 is cut in two parts each of which comprising, at its free end, a camming ramp surface 63, 65 which are complementary.

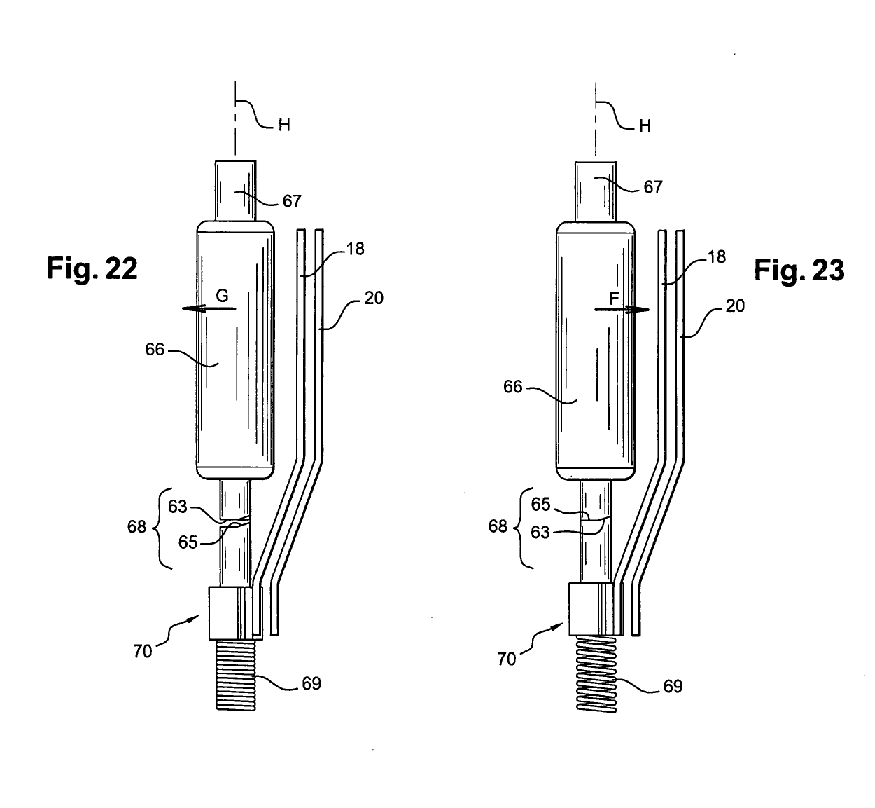

The design of end surfaces 63 and 65 is such that they provide for the driving of the cam 70 in one sense (clutching state illustrated at FIG. 23) and that the driving is impossible for the other sense of rotation (non clutching state illustrated at FIG. 22).

Although each roller 66 has very small dimensions and is substantially flush with the plane of the top face 92 of the cover 24, the sunken arrangement of the top face 38 of the button 26 can be used to act extremely efficiently on each roller.

The globally hemispherical bottom face of the thumb of the user received in the recess 101 between the rollers 66 arranged in a square thus behaves like a control rollerball or ball which encounters control surfaces 100, 38 of the various rollers 66 and/or the central button 26 respectively.

The number of pulses generated by each control shaft 22 associated with a set 16 of contact strips 18, 20 with which it forms a signal generator naturally depends on the number of lobes 72 of each cam 70.

Thus, by simply changing the number of lobes 72 of the cams 70, it is possible to have a greater or lesser number of pulses, for a complete rotation, on each of the “U, D, L, R” selection switching channels.

According to an embodiment variant not shown in the figures, it is possible (on each control shaft) to arrange two cams axially and angularly offset from one another, each of which acts on a set of associated fixed and mobile contact elements.

Thus, two cams with three lobes can be used to produce six pulses per rotation, unlike the embodiment shown in the figures in which each cam produces three pulses per rotation.

In addition, the design according to the invention proposes a control device which provides its user with a tactile sensation reflecting the validity of the operations performed.

The tactile sensation during the use of the central button 26 results, in known manner, from the design of the activation member 14 with a sudden change of state or collapsing.

The tactile sensation transmitted to the user by each control . shaft 16 with a drum or roller 66 results from the interaction of the cam 70 with multiple lobes 72 with the section 57, 58 supported by the elastically deformable strips which offer, on the one hand, a sensation of resistance to the rotation when the section “climbs” the length of the lobe then, on the other hand, a detent or clicking sensation when the section 57, 58 suddenly leaves the convex face of the lobe to fall again radially in the direction of the “H” axis.

These “mechanical” clicking or detent pulses during the rotation of a control shaft 66 correspond to each signal or electric pulse generated on the corresponding switching channel intended for the electronic signal or data processing circuits of the apparatus.

The device according to the embodiments illustrated in the figures has very small dimensions with the side of the bottom square body 12 about to 15 mm and, the height or thickness overall is about to 2 mm.

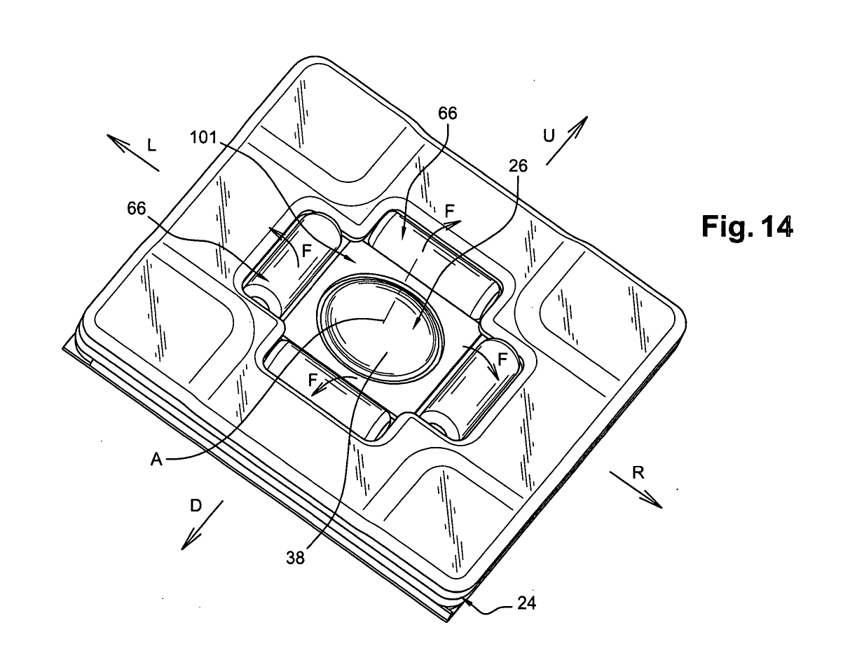

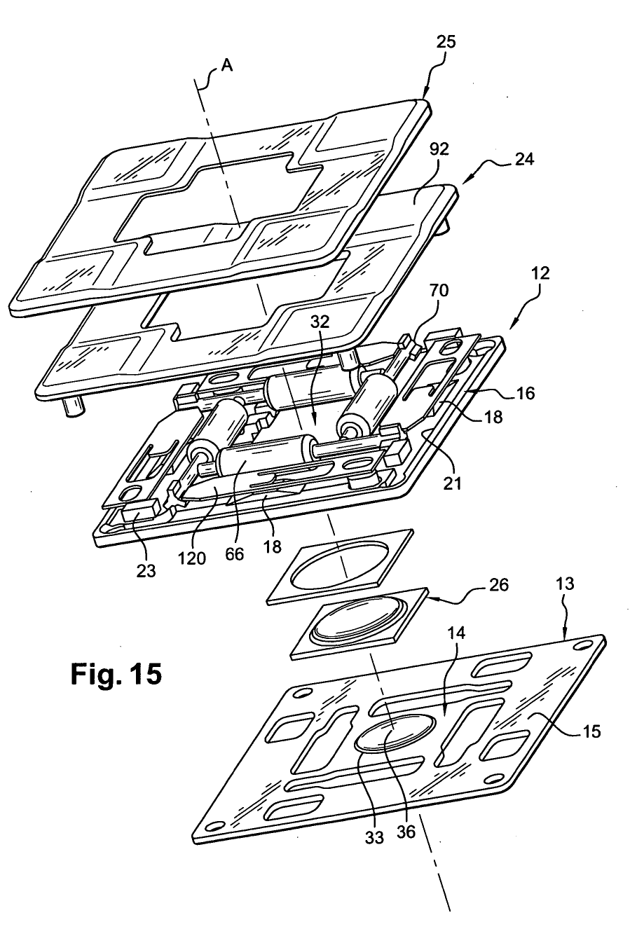

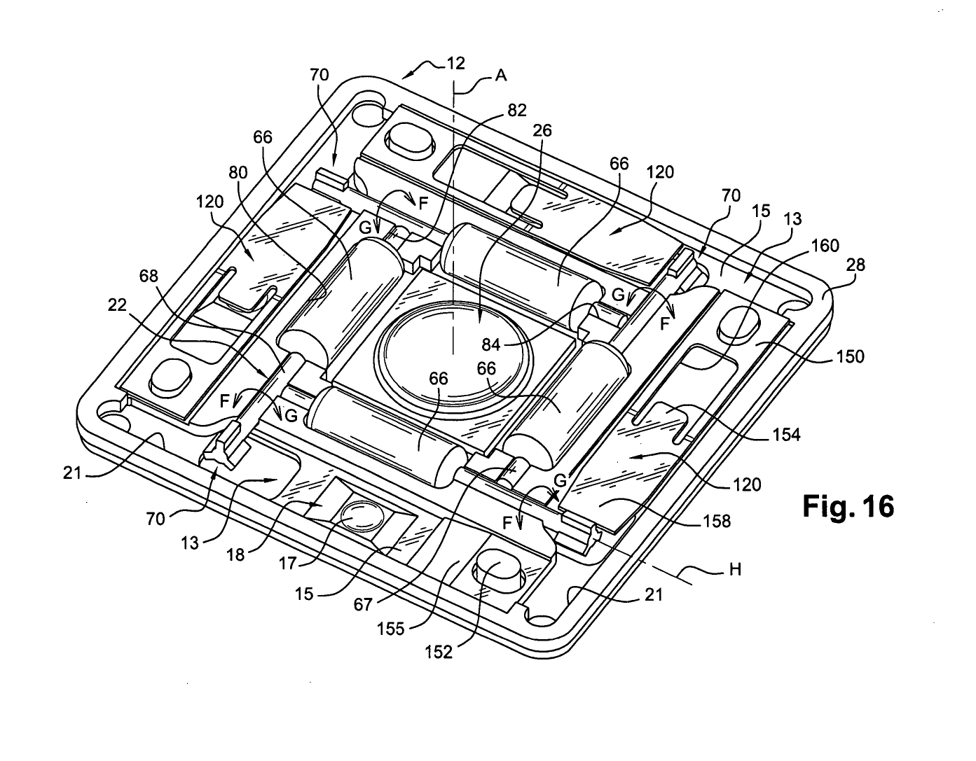

The second preferred embodiment of the invention will now be described with reference to FIGS. 14 to 19 in which elements or components identical, similar or analogous to those previously described will be designated by the same references.

According to the second preferred embodiment, each one of the four sets 16 of elements belonging to the four control signal generators comprises, according to a general design known in the field, a generally dome-shaped mobile spring contact element 18 which, by its bottom rectangular shaped peripheral edge 19, rests on the upper face 15 of an inferior printed circuit board (PCB) 13 which lies under the lower face of the bottom body 12. The top, actually dome-shaped, central portion 17 of the mobile contact element 18 extends, in its stable rest high position, vertically above and at a distance from upper face 15, through a corresponding opening 21 of the bottom body 12.

Each dome shaped mobile contact element 18 is associated with a fixed contact element (not shown) which, as already known, is comprised of conductive strips and/or plots on the upper face 15 of the PCB 13 so as to establish a corresponding switching way when the mobile contact element 18 is depressed and its central portion 17 leaves its high stable position towards a non stable low position in which it is in electrical contact with a corresponding conductive plot of the upper face of the PCB 13.

The central cavity 32 of the bottom body 12 receives the button 26 cooperating with the central activation member 14 which, according to a general design known in the field, is a generally dome-shaped member which, by its bottom circle shaped peripheral edge 33, rests on the upper face 15 of the PCB 13. Element 14 is associated with a fixed contact element (not shown) which, as already known, is comprised of a conductive strips and/or plots on the upper face 15 of the PCB 13 so as to establish a corresponding switching way when the element 14 is depressed and its central portion 36 leaves its high position towards a non stable low position in which it is in electrical contact with a corresponding conductive central plot of the upper face 15 of the PCB 13.

Consequently, all the “fixed” contact elements 18 are supported by the upper face 15 of the PCB 13.

The upper face 15 also supports, at its four opposite corners, four illuminating diodes 23, each of which also extends through an opening 21.

Alternately, the PCB 13 can be replaced by an isolating plastic inferior closing plate with overmoulded fixed contacts.

According to this preferred second embodiment of the invention, it is possible and very easy to guarantee the fluid and dust tightness of all the electrical critical contact elements and zones by providing a, not shown, film covering the mobile dome shaped contact elements 14 and 18 and the corresponding zones of the upper face 15 of the PCB 13.

A film is thus vertically interposed between the lower face of the bottom body 12, and the upper face 15 of the PCB.

The PCB 13 with the mobile contact elements 14, 18 and the film can be produced and assembled as a whole sub-assembly independently of the other components of the device.

For acting on each mobile contact element 18, each control signal generator comprises an actuator 120 which is made in the form of a horizontal plate.

Each plate 120 is made in the shape of a strip of material cut out and comprises an installation and fixing rear portion 150, an intermediate active portion 154 and a front end portion 158.

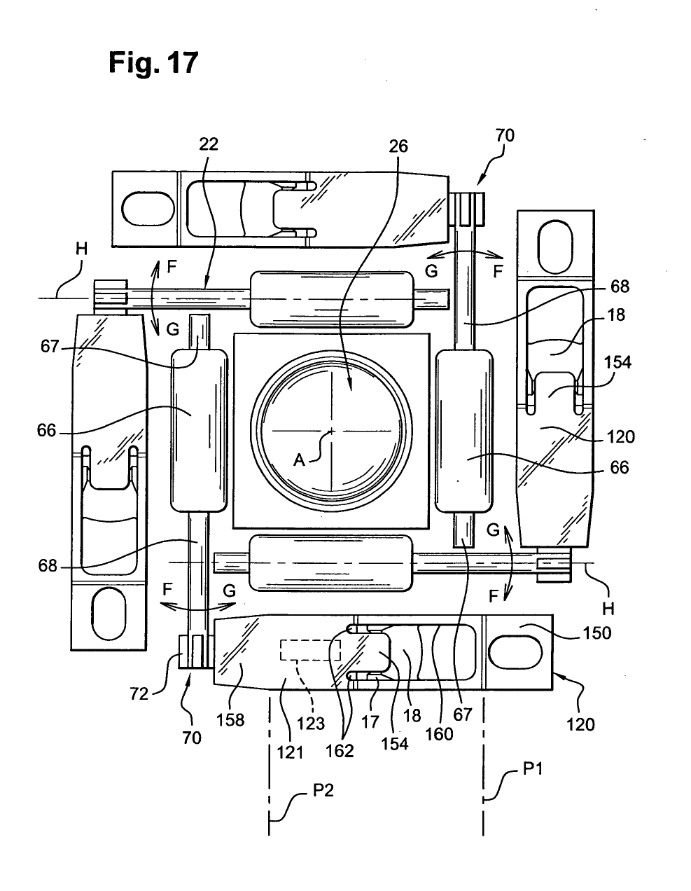

The front end portion 158 of the mobile contact 18 forms the control or actuating portion of the actuating plate with which the associated control shaft 22 interacts in order to elastically deform the plate so that its intermediate active portion 154 might act on the upper central portion 17 of the mobile contact element 18 which underlies under the intermediate active portion 154 as it can be seen from FIG. 17.

Each plate 120 is generally rectangular and elongated from its rear fixing portion to its front control portion 158.

The intermediate active portion 154 is in the form of a tab delimitated by two longitudinal slots 162 and a cut-out 160.

The rear fixing portion 150 is received on a fixing vertical foot 152, which might be hot welded, and lies over a horizontal surface 153 of the lower body 12. A downward inclined surface 155 is adjacent to the surface 153 and terminates in the open lower face of the body 12.

The actuating plate 120 thus constitutes a flexible beam arranged in a cantilevered fashion and which can be globally deformed around a rear pivoting axis P1 so that the intermediate active section 154 only slightly moves downwardly and does not act on the central upper portion 17 of the movable contact 18 and, consequently, there is no sufficient deformation thereof to establish a change of state of the corresponding switching way which remains open.

In its rest position, the actuating plate 120 is flat and horizontal and is slightly elastically prestressed upwardly with a portion of its upper face 121 bearing against a facing horizontal surface 123 protruding downwardly from the bottom flat face 86, of the upper cover 24.

Adjacent to the bearing surface 123, the bottom flat face 86 of the cover 24 comprises a cavity 125 which is delimited by an. inclined surface 127. The surfaces 123 and 127 are bounded by a common transverse line or edge 129.

The size and the position of the cavity 125 and of the control front end portion 158 of the plate 120 are such that this front portion 158 can be upwardly and elastically deformed by pivoting, in a lever manner, around a front pivoting axis P2—globally corresponding to the line 129—and be received in the cavity 125. In this case, the pivotal movement of the front end section 158 with the active intermediate section does provoke a corresponding downward and—vertical movement of the intermediate active portion 154 of the plate 120 which acts on the upper portion 17 of the mobile contact element 18 to fully depress it and establish, or close, the corresponding switching way.

Each control shaft 22 comprises a body or drum 66 for controlling its rotation about the axis “H” and which is extended axially by an intermediate section 68 which terminates in a cam 70 for acting on the front end portion 158 of the associated plate 120 which is ‘arranged perpendicularly to the associated shaft as it can be seen on FIG. 17.

The cam 70 comprises, according to this second embodiment, three protruding lobes or bosses 72 which project radially outwards.

Each lobe 72 has a symmetrical profile relative to an axial plane passing through the axis “H” thus having the shape of a tooth of a pinion.

The cam 70 is capable of acting on the associated control front end portion 158 of the associated plate 120 either to provoke the formation of a control signal, that is to say to establish a switching channel through the associated mobile contact element 18, or not to provoke any formation of a signal—depending on the direction or sense of rotation of the shaft, and thus of the cam 70.

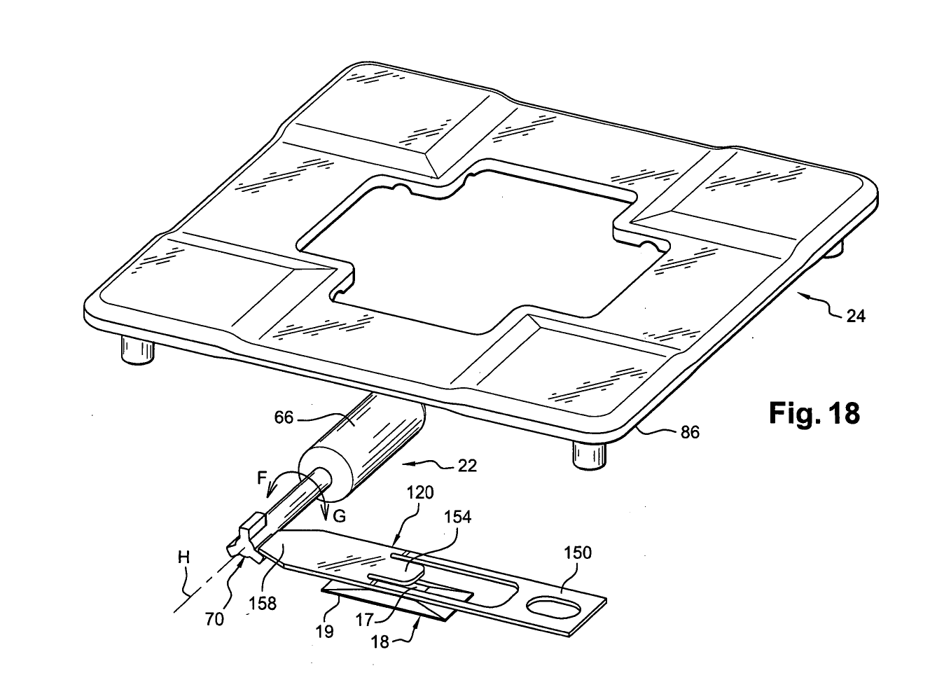

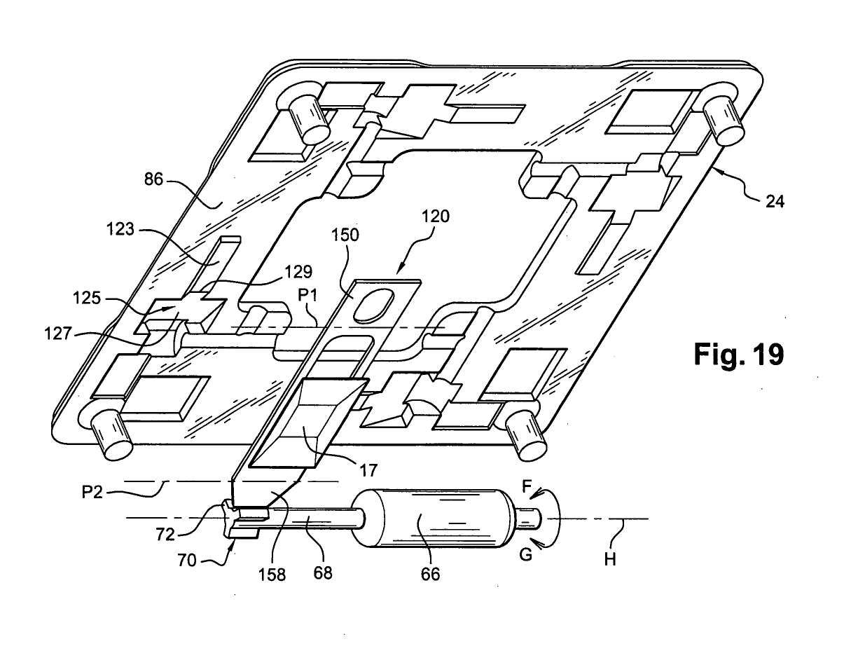

Thus, when a drum 66 rotates about its axis “H” in the direction of the arrow G indicated in FIGS. 18 and 19, the plate 120 does globally pivot around the rear horizontal axis P1 and its corresponding front section 158 is depressed downwardly and the mobile contact element 18 is not actuated by the intermediate active portion 154.

On the contrary, when a drum 66 rotates about its axis “H” in the direction of the arrow F indicated in FIGS. 18 and 19, the front section plate 120 does pivot around the front horizontal axis P2 and its corresponding front section 158 is deformed upwardly provoking a corresponding action of the intermediate active portion 154 on the mobile contact element 18 which reaches its low contact position.

According to the invention, each control shaft 22 is thus active for generating signals or pulses only when it is rotated in one single direction or sense of rotation F.

According to the invention, the single directions of rotation F of two opposite control shafts of a pair of opposite signal generators are opposite directions.

The top body or cover 24 is of general square shape matching the shape of the bottom body 12 and is covered by a protecting film 25.

The outer peripheral surface of each drum 66 is here flush and can be made of a material providing the user with a grip and/or a soft touch.

The invention is not limited to the embodiments that have just been described.

The means for generating pulses with which a control shaft interacts may be of any design.

It may also involve photoelectric or electromagnetic systems of the Hall effect type.

The thumb is the most suitable finger of a user for the “single finger” actuation of the device according to the invention, particularly when the device according to the invention is fitted to an electronic apparatus which is held in the hand of the user comprising this actuating finger.

However, the pairs of drums according to the invention may also be actuated with another finger, particularly when the electronic apparatus that is equipped with a device according to the invention is held by the other hand of the user or is placed on a support.

A device may also comprise a single pair of signal generators with parallel drums while retaining the aforementioned advantages, and particularly the extreme compactness.

Whether it comprises one or two pairs of signal generators with parallel drums, a control device according to the invention does not have to comprise a central selection key or button.

The designs according to the invention can also be used to integrate means of lighting or illumination, particularly of the button, and electromagnetic means of the type in order to provide the user with information or “active” tactile sensations (in closed loop), particularly when the control device, still called a “browser”, is used in conjunction with a degree of play, such that he has a “feedback” through a return pressure or force which represents the “quality” of the actual movement of the cursor on the screen.

These active or “qualitative” sensations or items of information are transmitted to the finger of the user while making it possible to reduce the user response time by thus “short-circuiting” his other senses such as eyesight and hearing.

What is claimed is:

1. Control device (10) of the type comprising a housing (12, 24) in which is arranged a rotating horizontal control shaft (22) that is able to be rotated by a manual drive drum (66) supported by the shaft (22) to which it is rotatably connected, and of the type in which the shaft (22) is rotatably connected to at least one rotary member (70, 72) belonging to a generator (22, 70, 16) of control signals or pulses for an electronic apparatus, particularly for the control of the movements of a cursor on a display screen of the apparatus, comprising:
at least one first pair (U-D, L-R) of opposite signal generators (22, 70, 16) whose rotating shafts (22) are parallel and whose two parallel and opposite actuating drums (66) can be accessed simultaneously in the top horizontal face (92) of the housing (24), in that each control shaft (22) is active for generating signals or pulses only when it is rotated in one single direction, and in that the said single directions of rotation of the two opposite control shafts of said at least first pair of opposite signal generators are opposite directions.

2. Control device according to the claim 1, wherein:
the axes (H) of rotation of the two control shafts (22) of the said first pair are arranged in a horizontal plane.

3. Control device (10) according to claim 1, wherein:
said two opposite drums (66) are spaced transversely one from the other and in that, between them, the said two opposite drums transversely delimit a central recess (101) in which a button (26, 38) is arranged for the vertical actuation of a central activation member (14) belonging to a supplementary electric switching channel of the control device (10) to generate selection signals, or pulses.

4. Control device (10) according to the claim 3 wherein:
said selection activation member (14) is a central member of conductive material and of generally bulbous form which is elastically deformable from a stable, high rest position to a low selection position in order to establish an electric link between two fixed contacts of the housing.

5. Control device (10) according to one of claim 3, wherein:
in the high, rest position of the activation member (14), the highest point of the top free actuation face (38) of the selection button (26) is offset vertically below the plane of the horizontal top face (92) of the housing (12, 24).

6. Control device (10) according to claim 1 comprising:
a first pair and a second pair of opposite signal generators (22, 70, 16) whose rotating shafts (22) are parallel and whose two parallel and opposite actuating drums (66) can be accessed simultaneously in the top horizontal face (92, 88, 94) of the housing (24), and in that the axes of rotation (H) of the four control shafts (22) are arranged in such a way as to form a quadrilateral rectangle, and in particular a square.

7. Control device (10) according to claim 6 wherein:
the axes (H) of rotation of the four control shafts (22) of the said two pairs are arranged in a horizontal plane.

8. Control device according to one of claim 6, wherein:
the four actuating drums (66) are arranged in a square, and the axial ends of two consecutive drums are adjacent to allow the simultaneous actuation of these two drums by one finger of the user.

9. Control device according to claim 6, wherein:
each control shaft (22) of said second pair is active for generating signals or pulses only when it is rotated in one single direction, and in that the said single directions of rotation of the two opposite control shafts of said second pair of opposite signal generators are opposite directions.

10. Control device (10) according to claim 1 wherein:
the outer peripheral surface of each actuating drum (66) comprises surface state characteristics (100) facilitating its actuation by a finger of a user in the said single direction of rotation.

11. Control device (10) according to claim 1 wherein:
said control device has a general symmetry of design about a central vertical axis of symmetry (A).
